(19) United States
(12) Patent Application Publication
(10) Pub. No.: US 2022/0278332 A1
(43) Pub. Date: Sep. 1, 2022

(54) ALL-SOLID-STATE LITHIUM BATTERY

(71) Applicant: TOYOTA JIDOSHA KABUSHIKI KAISHA, Toyota-shi Aichi-ken (JP)

(72) Inventor: Takuya Sugimoto, Toyota-shi Aichi-ken (JP)

(21) Appl. No.: 17/678,529

(22) Filed: Feb. 23, 2022

(30) Foreign Application Priority Data
Feb. 26, 2021 (JP) 2021-030506

(51) Int. Cl. H01M 4/62; H01M 10/0525

(52) U.S. Cl. CPC H01M 4/628; H01M 10/0525

(57) ABSTRACT

Provided is an all-solid-state lithium battery capable of suppressing short-circuiting caused by metallic Li creeping up on peripheral end faces. In the all-solid-state lithium battery, an anode mixture layer, a solid electrolyte layer, and a cathode mixture layer are layered in this order, a Li-occluding solid is disposed on at least part of peripheral end faces on the solid electrolyte layer, and the Li-occluding solid is responsive to Li.

### CROSS-REFERENCE TO RELATED APPLICATIONS

This application is based upon and claims the benefit of priority of the prior Japanese Patent Application No. 2021-030506 filed Feb. 26, 2021, the entire contents of which are incorporated herein by reference.

### FIELD

The present application relates to an all-solid-state lithium battery.

### BACKGROUND

Lithium secondary batteries are used in a wide range of fields because of high voltage and high energy capacity thereof. While a liquid-based battery is conventionally known as the lithium secondary battery, progress has been made in developing an all-solid battery that brings an advantage of an easier achievement of a simplified safety device than the liquid-based battery including an electrolytic solution containing a combustible organic solvent, in recent years.

Meanwhile, dendrites of metallic lithium grow in an anode mixture layer of a repeatedly charged and discharged all-solid-state battery, and reach a cathode active material layer thereof, which may cause an internal short circuit. Patent Literature 1 discloses the following technique to deal with such a problem.

Patent Literature 1 discloses a lithium secondary battery including construction of a positive electrode active material layer, a separator layer and a negative electrode active material layer laminated in that order, wherein the negative electrode active material layer comprises metallic lithium, the separator layer includes a shut layer and one or more solid electrolyte layer(s), one of the solid electrolyte layer(s) is adjacent to the negative electrode active material layer, and the shut layer comprises a lithium ion conductive liquid that reacts with the metallic lithium to produce an electronic insulator. The lithium secondary battery according to Patent Literature 1 includes the separator layer having a two-layer structure of the solid electrolyte layer(s) and the shut layer, and is provided with the shut layer on the positive electrode active material layer side, thereby suppressing metallic lithium deposited from the negative electrode active material layer reaching the positive electrode active material layer, and then short-circuiting.

### CITATION LIST

### Patent Literature

Patent Literature 1: JP 2020-53172 A

### SUMMARY

### Technical Problem

It is known that short-circuiting is caused by metallic Li creeping up from an anode mixture layer priorly on peripheral end faces. Therefore, it is important to suppress short-circuiting caused by metallic Li creeping up on peripheral end faces.

The technique of Patent Literature 1 is believed to be effective in suppressing short-circuiting caused by metallic Li creeping up on peripheral end faces. However, it may be difficult to maintain such an effect irrespective of construction of a battery. For example, when Si, graphite, or the like, which is expandable and shrinkable, is used in the negative electrode active material, it is considered that long-term charge and discharge or rapid charge and discharge makes a gap between the shut layer and a layer adjacent thereto work like a pump and as a result the lithium ion conductive liquid held inside the shut layer leaks to the outside. It is also considered that binding a battery under high pressure for reducing the resistance causes the amount of such battery leakage to be more. When the lithium ion conductive liquid leaks to the outside, it is believed that the effect of suppressing short-circuiting diminishes, so that the originally expected effect does not show. Thus, there is a room for improvement in the technique in Patent Literature 1.

With the foregoing actual circumstances in view, an object of the present application is to provide an all-solid-state lithium battery capable of suppressing short-circuiting caused by metallic Li creeping up on peripheral end faces.

### Solution to Problem

The present disclosure is provided with, as one technique for solving the above problems, an all-solid-state lithium battery, wherein an anode mixture layer, a solid electrolyte layer, and a cathode mixture layer are layered in this order, a Li-occluding solid is disposed on at least part of peripheral end faces on the solid electrolyte layer, and the Li-occluding solid is responsive to Li.

In the all-solid-state lithium battery, the peripheral end faces on the anode mixture layer, the solid electrolyte layer, and the cathode mixture layer may be flat. In addition, the Li-occluding solid may be disposed on the part of the peripheral end faces on the solid electrolyte layer on an anode mixture layer side.

Further, the all-solid-state lithium battery may comprise: an anode current collector disposed on a surface of the anode mixture layer, the surface being on an opposite side of the solid electrolyte layer; and a cathode current collector disposed on a surface of the cathode mixture layer, the surface being on an opposite side of the solid electrolyte layer, wherein the anode current collector may include an anode current collector tab, the cathode current collector may include a cathode current collector tab, the anode current collector tab and the cathode current collector tab may be disposed on one same peripheral end face among the peripheral end faces as sticking out, and the Li-occluding solid may be disposed on a peripheral end face among the peripheral end faces on the solid electrolyte layer, the peripheral end face being the one same peripheral end face, where the anode current collector tab and the cathode current collector tab are disposed. In addition, the Li-occluding solid may be disposed across the part of the peripheral end faces on the solid electrolyte layer in a circumferential direction.

### Effects

The all-solid-state lithium battery according to the present disclosure is capable of suppressing short-circuiting caused by metallic Li creeping up on peripheral end faces.

### BRIEF DESCRIPTION OF DRAWINGS

FIG. 1 explanatorily shows short-circuiting caused by metallic Li creeping up on peripheral end faces;

FIG. 2. is a cross-sectional view of an all-solid-state lithium battery 10;

FIG. 3 is a plan view of the all-solid-state lithium battery 10;

FIG. 4A explanatorily shows a method for manufacturing the all-solid-state lithium battery 10;

FIG. 4B explanatorily shows the method for manufacturing the all-solid-state lithium battery 10;

FIG. 4C explanatorily shows the method for manufacturing the all-solid-state lithium battery 10;

FIG. 5A is an explanatory cross-sectional views of placement positions of Li-occluding solids in evaluation batteries of Examples 1 and 3 to 5 and Comparative Example 1 in the layering direction;

FIG. 5B is an explanatory cross-sectional views of placement positions of Li-occluding solids in evaluation batteries of Example 2 in the layering direction; and

FIG. 6 is an explanatory plan view of shapes of the evaluation batteries of Examples 1 to 5 and Comparative Example 1.

### DESCRIPTION OF EMBODIMENTS

One feature of an all-solid-state lithium battery according to the present disclosure is that an anode mixture layer, a solid electrolyte layer, and a cathode mixture layer are layered in this order, a Li-occluding solid is disposed on at least part of peripheral end faces on the solid electrolyte layer, and the Li-occluding solid is responsive to Li.

The all-solid-state lithium battery according to the present disclosure includes a Li-occluding solid on at least part of peripheral end faces on the solid electrolyte layer. The Li-occluding solid is reactive to metallic Li. The Li-occluding solid can react with metallic Li creeping up on peripheral end faces and occlude the metallic Li thereinside. Thus, the all-solid-state lithium battery according to the present disclosure is capable of suppressing short-circuiting caused by metallic Li creeping up on peripheral end faces.

In the all-solid-state lithium battery according to the present disclosure, the peripheral end faces on the anode mixture layer, the solid electrolyte layer, and the cathode mixture layer are flat. “Peripheral end faces” means a side surface when the end faces of the all-solid-state lithium battery in the layering direction are each defined as a top face and a bottom face, and faces formed of outer edges of the anode mixture layer, the solid electrolyte layer, and the cathode mixture layer. “The peripheral end faces are flat” means that there is no difference in level in each of the peripheral end faces and each of the peripheral end faces on the respective layers is on the same plane. It is noted that manufacturing errors are acceptable. For example, the peripheral end face can be said to be flat if difference in level thereof between each layer is within 0.5 mm.

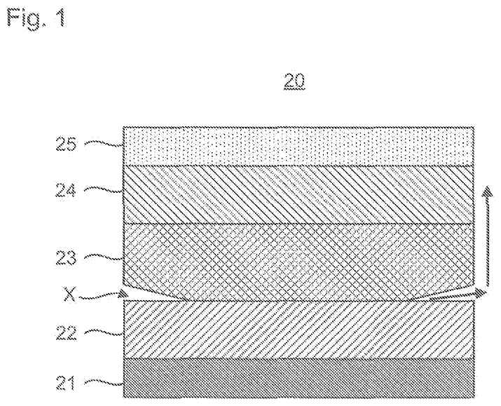

In an all-solid-state lithium battery including flat peripheral end faces, short-circuiting is caused most priorly by metallic Li creeping up on the peripheral end faces, which will be described in detail with reference to FIG. 1.

FIG. 1 explanatorily shows a state where short-circuiting is caused by metallic Li creeping up on peripheral end faces in an all-solid-state lithium battery 20 including flat peripheral end faces. The all-solid-state lithium battery 20 is formed by layering an anode current collector 21, an anode mixture layer 22, a solid electrolyte layer 23, a cathode mixture layer 24, and a cathode current collector 25 in this order. When an expandable and shrinkable anode active material is used in such an all-solid-state lithium battery 20 including flat peripheral end faces, a gap X is generated between the anode mixture layer 22, which expands and shrinks according to charge and discharge, and the solid electrolyte layer 23, which does not expand or shrink. Metallic Li deposited on the anode mixture layer 22 moves to the peripheral end faces side through this gap X. The metallic Li having moved to peripheral end faces extends to the cathode mixture layer 24 side (arrows in FIG. 1). Then, the metallic Li reaches the cathode mixture layer 24, which causes short-circuiting. As described above, the metallic Li deposited on the anode mixture layer 22 passes through the gap X to move to peripheral end faces, and then creeps up to the cathode mixture layer 24 side. Thus, short-circuiting is caused most priorly by the metallic Li creeping up on peripheral end faces.

In a conventional all-solid-state lithium battery, the size of each of the anode mixture layer and the solid electrolyte layer is designed to be larger than that of the cathode mixture layer, so that there is difference in level on the peripheral end faces between the cathode mixture layer, and the anode mixture layer and the solid electrolyte layer. This difference in level suppresses metallic Li creeping up on the peripheral end faces. As described above, in view of suppressing short-circuiting caused by creeping-up metallic Li, the size of each of the anode mixture layer and the solid electrolyte layer is larger than that of the cathode mixture layer. However, if the size of each layer is different, it is necessary to figure out a way of pressing these layers or how to shape a pressing mold for these layers in manufacturing steps. Therefore, desirably, each layer is formed to have substantially the same size.

However, when the size of each layer is the same and the peripheral end faces are flat, short-circuiting by metallic Li creeping up on peripheral end faces is a problem as in FIG. 1. The technique in Patent Literature 1 is to have the entire separator layer with a shut function. However, short-circuiting to be priorly suppressed is short-circuiting caused by metallic Li creeping up on peripheral end faces. In addition, it is feared that the technique in Patent Literature 1 might lead to battery leakage as described above.

In contrast, the all-solid-state lithium battery according to the present disclosure includes a Li-occluding solid on the peripheral end faces on the solid electrolyte layer, which can suppress extension of metallic Li creeping up on the peripheral end faces to the cathode mixture layer. Thus, the all-solid-state lithium battery according to the present disclosure is capable of suppressing short-circuiting caused by metallic Li creeping up on peripheral end faces even when the peripheral end faces are flat.

The all-solid-state lithium battery according to the present disclosure is effective especially when the peripheral end faces are flat. The present disclosure is not limited to this. The all-solid-state lithium battery according to the present disclosure is also effective when there is difference in level on the peripheral end faces.

Hereinafter the all-solid-state lithium battery according to the present disclosure will be further described with reference to an all-solid-state lithium battery 10 including flat peripheral end faces.

[All-Solid-State Lithium Battery 10]

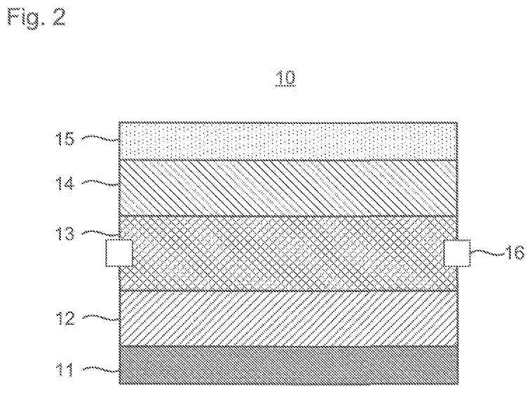

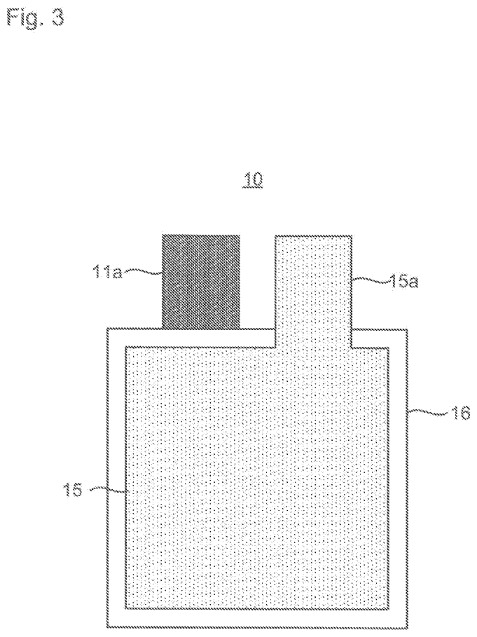

FIG. 2 is a cross-sectional view of the all-solid-state lithium battery 10. FIG. 3 is a plan view of the all-solid-state lithium battery 10 observed over the top face. As shown in FIGS. 2 and 3, the all-solid-state lithium battery 10 is formed by layering an anode mixture layer 12, a solid electrolyte layer 13, and a cathode mixture layer 14 in this order. The all-solid-state lithium battery 10 is provided with an anode current collector 11 disposed on a surface of the anode mixture layer 12 which is on the opposite side of the solid electrolyte layer 13, and a cathode current collector 15 disposed on a surface of the cathode mixture layer 14 which is on the opposite side of the solid electrolyte layer. The anode current collector 11 is provided with an anode current collector tab 11a sticking out of a peripheral end face. The cathode current collector 15 is provided with a cathode current collector tab 15a sticking out of a peripheral end face. Further, the all-solid-state lithium battery 10 includes a Li-occluding solid 16 on peripheral end faces on the solid electrolyte layer 13. In the all-solid-state lithium battery 10, the peripheral end faces on the anode mixture layer 12, the solid electrolyte layer 13, and the cathode mixture layer 14 are flat.

(Anode Current Collector 11 and Cathode Current Collector 15)

The anode current collector 11 and the cathode current collector 15 may be constituted of metal foil, metal mesh, or the like, and examples of a metal therein include Cu, Ni, Al, Fe and stainless steel. The thicknesses of the anode current collector 11 and the cathode current collector 15 may be suitably set according to a desired battery performance, and for example, are each in the range of 0.1 μm and 1 mm.

(Anode Mixture Layer 12)

The anode mixture layer 12 contains an anode active material. The anode active material is not particularly limited as long as being usable for all-solid-state lithium batteries, and as long as being expandable and shrinkable according to charge and discharge. Examples of the anode active material include Si-based active materials such as Si, and carbon materials such as graphite. The particle size of the anode active material is not particularly limited, but for example, is in the range of 0.1 μm and 100 μm. The content of the anode active material in the anode mixture layer 12 is not particularly limited, but for example, is in the range of 10 wt % and 99 wt %.

Here, in this description, “particle size” means a particle diameter at a 50% integrated value (D₅₀) in a volume-based particle diameter distribution that is measured using a laser diffraction and scattering method.

The anode mixture layer 12 may optionally contain a solid electrolyte. The solid electrolyte is not particularly limited as long as capable of being applied to all-solid-state lithium batteries. Examples of the solid electrolyte include oxide solid electrolytes and sulfide solid electrolytes. Examples of the oxide solid electrolytes include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ (LiPON). Examples of the sulfide solid electrolytes include Li₃PS₄, Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. The content of the solid electrolyte in the anode mixture layer 12 is not particularly limited, but for example, is in the range of 1 wt % and 50 wt %.

The anode mixture layer 12 may optionally contain a conductive additive. The conductive additive is not particularly limited as long as capable of being applied to all-solid-state lithium batteries. Examples of the conductive additive include carbon materials such as acetylene black, Ketjenblack, and vapor grown carbon fiber (VGCF), and metallic materials such as nickel, aluminum and stainless steel. The content of the conductive additive in the anode mixture layer 12 is not particularly limited, but for example, is in the range of 0.1 wt % and 20 wt %.

The anode mixture layer 12 may optionally contain a binder. Examples of the binder include butadiene rubber (BR), butyl rubber (IIR), acrylate-butadiene rubber (ABR), carboxymethyl cellulose (CMC), polyvinylidene fluoride (PVdF), and polyvinylidene fluoride-hexafluoropropylene copolymer (PVDF-HFP). The content of the binder in the anode mixture layer 12 is not particularly limited, but for example, is in the range of 0.1 wt % and 20 wt %.

The content of each constituent in the anode mixture layer 12 may be the same as in conventional ones. The shape of the anode mixture layer 12 is not particularly limited, but in such a viewpoint that the anode mixture layer 12 can be easily layered, is in the form of a sheet. The thickness of the anode mixture layer 12 is not particularly limited, but for example, is in the range of 0.1 μm and 1 mm.

(Solid Electrolyte Layer 13)

The solid electrolyte layer 13 contains a solid electrolyte. The solid electrolyte same as that usable in the anode mixture layer 12 may be used. The content of the solid electrolyte in the solid electrolyte layer 13 is, for example, in the range of 50 wt % and 99 wt %.

The solid electrolyte layer 13 may optionally contain a binder. The binder same as that usable in the anode mixture layer 12 may be used. The content of the binder in the solid electrolyte layer 13 is not particularly limited, but for example, in the range of 0.1 wt % and 10 wt %.

The content of each constituent in the solid electrolyte layer 13 may be the same as in conventional ones. The shape of the solid electrolyte layer 13 is not particularly limited, but in such a viewpoint that the solid electrolyte layer 13 can be easily layered, is in the form of a sheet. The thickness of the solid electrolyte layer 13 is not particularly limited, but for example, is in the range of 0.1 μm and 1 mm.

(Cathode Mixture Layer 14)

The cathode mixture layer 14 contains a cathode active material. The cathode active material is not particularly limited as long as capable of being applied to all-solid-state lithium batteries. Examples of the cathode active material include lithium-containing composite oxides such as lithium cobaltate, lithium nickelate, LiNi_{1/3}Co_{1/3}Mn_{1/3}O₂, lithium manganate and spinel lithium compounds. The particle size of the cathode active material is not particularly limited, but for example, is in the range of 5 μm and 100 μm. The content of the cathode active material in the cathode mixture layer 12 is, for example, in the range of 50 wt % and 99 wt %. The surface of the cathode active material may be coated with an oxide layer such as a lithium niobate layer, a lithium titanate layer and a lithium phosphate layer.

The cathode mixture layer 14 may optionally contain a solid electrolyte. The solid electrolyte same as that usable in the anode mixture layer 12 may be used. The content of the solid electrolyte in the cathode mixture layer 14 is, for example, in the range of 1 wt % and 50 wt %.

The cathode mixture layer 14 may optionally contain a conductive additive. The conductive additive same as that usable in the anode mixture layer 12 may be used. The content in the conductive additive in the cathode mixture layer 14 is, for example, in the range of 0.1 wt % and 10 wt %.

The cathode mixture layer 14 may optionally contain a binder. The binder same as that usable in the anode mixture layer 12 may be used. The content in the binder in the cathode mixture layer 14 is, for example, in the range of 0.1 wt % and 10 wt %.

The content of each constituent in the cathode mixture layer 14 may be the same as in conventional ones. The shape of the cathode mixture layer 14 is not particularly limited, but in such a viewpoint that the cathode mixture layer 14 can be easily layered, is in the form of a sheet. The thickness of the cathode mixture layer 14 is not particularly limited, but for example, is in the range of 0.1 μm and 1 mm.

(Li-Occluding Solid 16)

The Li-occluding solid 16 is disposed on at least part of peripheral end faces on the solid electrolyte layer 13. Such a Li-occluding solid 16 is disposed on peripheral end faces on the solid electrolyte layer 13, whereby metallic Li creeping up from the anode mixture layer 12 to the cathode mixture layer 14 reacts with the Li-occluding solid 16 on the peripheral end faces, which causes the Li-occluding solid 16 to occlude the metallic Li thereinside. Thus, the all-solid-state lithium battery 10 can suppress short-circuiting caused by metallic Li creeping up on peripheral end faces.

The Li-occluding solid 16 is not particularly limited as long as being able to stably exist in the solid electrolyte layer 13 and as long as being reactive with metallic Li. Examples of the Li-occluding solid 16 include aluminum and indium. The thickness of the Li-occluding solid 16 (length on peripheral end faces in the layering direction) is not particularly limited, but for example, is 10 μm to 100 μm.

The Li-occluding solid 16 shows the foregoing effect as long as disposed on at least part of the peripheral end faces. In some embodiments, the Li-occluding solid 16 is disposed on a portion where metallic Li is easily deposited.

Specifically, the Li-occluding solid 16 is disposed on peripheral end faces on the solid electrolyte layer 13 on the anode mixture layer 12 side because metallic Li is easily deposited on the anode mixture layer 12. “Anode mixture layer 12 side” means a range of the peripheral end faces on the solid electrolyte layer 13 in the layering direction which is less than 50% from the anode mixture layer 12 when the length between the anode mixture layer 12 and the cathode mixture layer 14 is defined as 100%. In some embodiments, this range is at most 30%, at most 20%, at most 10%, or includes a portion including the interface between the anode mixture layer 12 and the solid electrolyte layer 13.

The Li-occluding solid 16 is disposed on a peripheral end face where any of the current collector tabs (the anode current collector tab 11a and/or the cathode current collector tab 15) is disposed as sticking out because currents are concentrated on a current collector tab and therearound, which makes it easy to deposit metallic Li. Between them, the Li-occluding solid 16 is disposed on a peripheral end face where the anode current collector tab 11a is disposed as sticking out.

In some embodiments, the anode current collector tab 11a and the cathode current collector tab 15a are disposed as sticking out of the same peripheral end face, and the Li-occluding solid 16 is disposed on one peripheral end face among the peripheral end faces on the solid electrolyte layer 13 where the anode current collector tab 11a and the cathode current collector tab 15a are disposed.

“Disposed on peripheral end faces” means that the Li-occluding solid 16 is disposed on at least part of peripheral end faces on the solid electrolyte layer 13, and is disposed across the foregoing peripheral end faces in the width direction (direction orthogonal to the layering direction on the peripheral end faces). When being disposed across the foregoing peripheral end faces in the width direction, the Li-occluding solid 16 may be disposed across part (for example, the range within 50% of the length in the width direction) or all of one or both peripheral end face(s) adjacent to the foregoing peripheral end faces in the width direction.

In some embodiments, the Li-occluding solid 16 is disposed across the peripheral end faces on the solid electrolyte layer 13 in the circumferential direction (entire periphery) (FIG. 3). Here, the placement positions of the current collector tabs are not particularly limited.

When the Li-occluding solid 16 is actually disposed on the solid electrolyte layer 13, it is necessary to determine the thickness thereof and the placement position on the peripheral end face(s) in view of the volume expansivity when the Li-occluding solid 16 occludes Li, in addition to the foregoing matters.

(Method for Manufacturing all-Solid-State Lithium Battery 10)

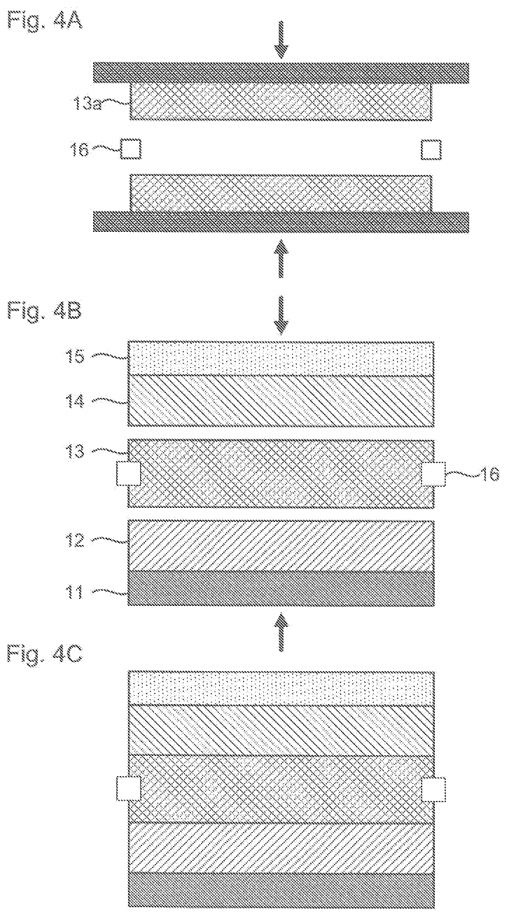

Next, a method for manufacturing the all-solid-state lithium battery 10 will be described. FIGS. 4A to 4C explanatorily show a method for manufacturing the all-solid-state lithium battery 10.

First, as advance preparation, the anode mixture layer 12, the cathode mixture layer 14, and two layered solid electrolytes 13a to constitute the solid electrolyte layer 13 are prepared (first step). The layered solid electrolytes 13a have the same constitution as the solid electrolyte layer 13. The solid electrolyte layer 13 can be prepared by uniting the layered solid electrolytes 13a as described later.

Any known method may be employed for preparing these layers. For example, when the cathode mixture layer 14 is prepared, materials to constitute the cathode mixture layer 14 are mixed and pressed under a predetermined pressure. Whereby the cathode mixture layer 14 can be prepared. The cathode mixture layer 14 can be also prepared by mixing materials to constitute the cathode mixture layer 14 with a predetermined solvent to form a slurry, and next applying the slurry to a substrate or the cathode current collector 15, and drying the resultant. The anode mixture layer 12 and the layered solid electrolytes are prepared in the same way.

Next, as shown in FIG. 4A, the Li-occluding solid 16 in the form of a line is disposed between edge portions of the two layered solid electrolytes 13a. The Li-occluding solid 16 is held between these layered solid electrolytes 13a, and pressure is applied thereto. Whereby the solid electrolyte layer 13, where the Li-occluding solid 16 is disposed on peripheral end faces, can be obtained (second step). The pressure application conditions in the second step may be suitably set, and is, for example, three-minute compression at 100 kN.

After the second step, as shown in FIG. 4B, the anode mixture layer 12 is disposed on one side, and the cathode mixture layer 14 is disposed on the other side of the solid electrolyte layer 13, and pressure is applied thereto (third step). Whereby, as shown in FIG. 4C, the all-solid-state lithium battery 10 can be prepared.

Here, when pressure is applied in the third step, the anode current collector 11 may be disposed on the anode mixture layer 12, and the cathode current collector 15 may be disposed on the cathode mixture layer 14. If each of the current collectors is not disposed, a step of disposing the anode current collector 11 on the anode mixture layer 12 and disposing the cathode current collector 15 on the cathode mixture layer 14 may be provided as the next step (fourth step). The pressure application conditions in the third step may be the same as conventional conditions.

When the Li-occluding solid 16 is disposed on a portion including the interface between the anode mixture layer 12 and the solid electrolyte layer 13, the Li-occluding solid 16 may be disposed and held between the anode mixture layer 12 and the solid electrolyte layer 13, and pressure may be applied thereto.

### EXAMPLES

The all-solid-state lithium battery according to the present disclosure will be hereinafter further described with reference to Examples. Matters that are necessary for enabling the technique disclosed herein and that are other than those specifically mentioned in the present description may be grasped as design matters by the person skilled in the art based on conventional arts in this field. The present disclosure is enabled based on the contents disclosed in the present description, and the technical common sense in this field. The following examples are not intended to limit the technique disclosed herein. In the drawings indicated in the present description, the proportions of measures (such as length, width and thickness) in each figure do not reflect the actual proportions.

[Preparing Evaluation Batteries]

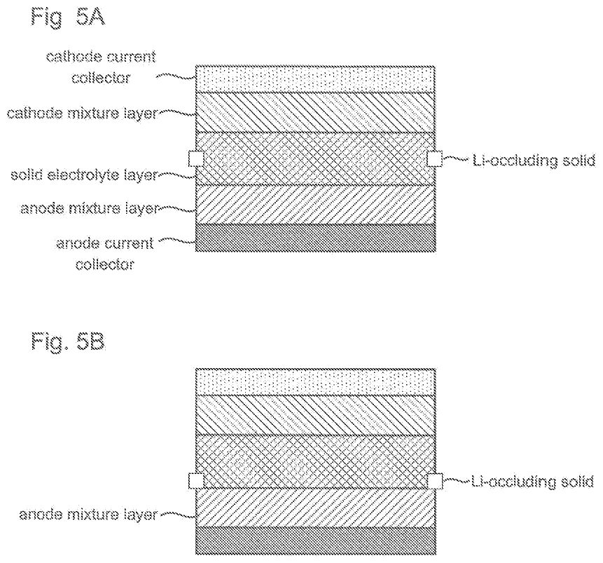

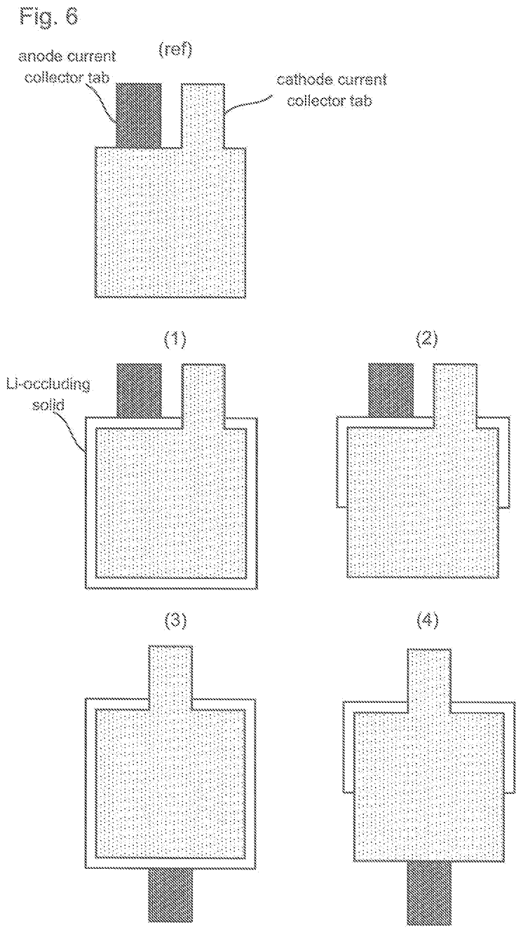

Evaluation batteries of Examples 1 to 5 and Comparative Example 1 were prepared as the following description. FIGS. 5A and 5B are explanatory cross-sectional views of placement positions of Li-occluding solids in the evaluation batteries in the layering direction. FIG. 6 is an explanatory plan view of shapes of the evaluation batteries.

### Example 1

### (Preparing Cathode Mixture Layer)

Lithium cobaltate (LiCoO₂) as a cathode active material, and Li₂S—P₂S₅ (mass ratio: Li₂S:P₂S₅=70:30) as a sulfide-based solid electrolyte were weighed, so that the weight ratio was: cathode active material:sulfide-based solid electrolyte=75:25. Then, 4 parts by weight of a PVdF-based binder, and 6 parts by weight of a conductive material (acetylene black) were weighed to 100 parts by weight of the cathode active material. These were blended in butyl butyrate, so as to have a solid content of 70 wt %. The resultant was kneaded by a stirrer. Whereby a composition for forming a cathode mixture layer (cathode slurry) was obtained. One side of Al foil (cathode current collector) was coated with this cathode slurry and dried, to form the cathode mixture layer.

(Preparing Anode Mixture Layer)

Carbon as an anode active material, and Li₂S—P₂S₅ (mass ratio: Li₂S:P₂S₅=70:30) as a sulfide-based solid electrolyte were weighed, so that the weight ratio was anode active material:sulfide-based solid electrolyte=55:45. Then, 6 parts by weight of a PVdF-based binder, and 6 parts by weight of a conductive material (acetylene black) were weighed to 100 parts by weight of the anode active material. These were blended in butyl butyrate, so as to have a solid content of 70 wt %. The resultant was kneaded by a stirrer. Whereby a composition for forming an anode mixture layer (anode slurry) was obtained. One side of Cu foil (anode current collector) was coated with this anode slurry and dried, to form the anode mixture layer.

(Preparing Layered Solid Electrolyte)

Weighed were 98 parts by weight of the sulfide-based solid electrolyte same as that used for the cathode and anode slurries, and 2 parts by weight of a SBR (styrene-butadiene rubber)-based binder. These were blended in a heptane solvent, so as to have a solid content of 70 wt %. The resultant was subjected to ultrasonic dispersing by an ultrasonic dispersive device for 2 minutes. Whereby a composition for forming a solid electrolyte layer (solid electrolyte slurry) was obtained. One side of Al foil was coated with this solid electrolyte slurry and dried, to form a layered solid electrolyte.

(Preparing Evaluation Batteries)

A solid electrolyte layer was prepared using two of the layered solid electrolytes each having a thickness of 50 μm, and a Li-occluding solid (Al wire, 25 μm in thickness). Specifically, the Li-occluding solid was disposed between the two layered solid electrolytes, so as to be disposed across edge portions of the layered solid electrolytes in the circumferential direction. The Li-occluding solid was held between these layered solid electrolytes, and pressure was applied thereto. Then, the solid electrolyte layer (100 μm in thickness), where the Li-occluding solid was disposed on peripheral end faces, was prepared. The pressure application conditions were three-minute compression at 100 kN.

Next, the anode mixture layer, where the anode current collector (Cu foil) was layered, was disposed on one side, and the cathode mixture layer, where the cathode current collector (Al foil) was layered, was disposed on the other side of the obtained solid electrolyte layer, and the resultant was bound. At this time, the battery was prepared in such a manner that an anode current collector tab and a cathode current collector tab were disposed as sticking out of the same peripheral end face. The binding condition was 5 MPa. The evaluation battery of Example 1 was prepared according to the foregoing.

Here, the prepared evaluation battery of Example 1 had a cross section as FIG. 5A, and a shape as (1) of FIG. 6.

### Example 2

The evaluation battery of Example 2 was prepared in the same manner as the evaluation battery of Example 1 except that layered solid electrolytes each having a thickness of 100 μm were used for the solid electrolyte layer, and that the Li-occluding solid was disposed on the peripheral end faces on the solid electrolyte layer on the anode mixture layer side. The evaluation battery of Example 2 prepared as described above had a cross section as FIG. 5B, and a shape as (1) of FIG. 6 as that of Example 1.

### Example 3

The evaluation battery of Example 3 was prepared in the same manner as the evaluation battery of Example 1 except that the Li-occluding solid was disposed on a peripheral end face where the anode current collector tab and the cathode current collector tab were disposed as sticking out. Specifically, when the solid electrolyte layer was prepared, the Li-occluding solid was disposed between the two layered solid electrolytes, so as to be disposed across the peripheral end face, where the anode current collector tab and the cathode current collector tab were disposed as sticking out in the width direction and so as to be disposed across two peripheral end faces adjacent to the foregoing peripheral end face within the range of 50% of the lengths of the two peripheral end faces in the width direction. The evaluation battery of Example 3 prepared as described above had a cross section as FIG. 5A, and a shape as (2) of FIG. 6.

### Example 4

The evaluation battery of Example 4 was prepared in the same manner as the evaluation battery of Example 1 except that the anode current collector tab and the cathode current collector tab were disposed as sticking out of respective peripheral end faces opposite to each other. The evaluation battery of Example 4 prepared as described above had a cross section as FIG. 5A, and a shape as (3) of FIG. 6.

### Example 5

The evaluation battery of Example 5 was prepared in the same manner as the evaluation battery of Example 3 except that the anode current collector tab and the cathode current collector tab were disposed as sticking out of respective peripheral end faces opposite to each other. Here, the peripheral end face, where the Li-occluding solid was disposed, was the peripheral end face, where the cathode current collector tab was disposed as sticking out. The evaluation battery of Example 5 prepared as described above had a cross section as FIG. 5A, and a shape as (4) of FIG. 6.

### Comparative Example 1

The evaluation battery of Comparative Example 1 was prepared in the same manner as the evaluation battery of Example 1 except that the solid electrolyte layer was prepared without the Li-occluding solid disposed. The evaluation battery of Comparative Example 1 prepared as described above had a shape as (ref) of FIG. 6.

[Evaluation]

The voltage reduction amount after a cycle test was measured using the prepared evaluation batteries of Examples 1-5 and Comparative Example 1. Here, the temperature in the cycle test was 25° C. Hereinafter the cycle test will be described.

First, the evaluation batteries were each initially conditioned. In the initial conditioning, the charge conditions were: 4.2 V-CCCV charging, 1 C in current rate, and 0.1 C in cut current; and the discharge conditions were: CC, 3.0 V in cut current, and 1 C in current rate. Next, a charge/discharge cycle at 5 C between 3.0 and 4.5 V was repeated five times. Then, the battery voltage was conditioned to 4.0 V, and the voltage reduction amount after 24 hours was measured. The case where the voltage reduction amount was at most 2 mV was represented by “excellent”, the case where the voltage reduction amount was more than 2 mV and at most 5 mV was represented by “good”, the case where the voltage reduction amount was more than 5 mV and at most 15 mV was represented by “fair”, and the case where the voltage reduction amount took any other value was represented by “poor”. The results are shown in Table 1.

TABLE 1

| | Li-occluding solid | | | Voltage | |
|---|---|---|---|---|---|
| | | Position in | Shape of peripheral | reduction | |
| | Material | layering direction | end face | amount (mV) | Determination |
| Comparative | — | — | ref | 50 | poor |
| Example 1 | | | | | |
| Example 1 | Al | A | 1 | 4 | good |
| Example 2 | Al | B | 1 | 2 | excellent |
| Example 3 | Al | A | 2 | 5 | good |
| Example 4 | Al | A | 3 | 3 | good |
| Example 5 | Al | A | 4 | 15 | fair |

As in Table 1, the voltage reduction amount was smaller in each of Examples 1 to 5 compared to that in Comparative Example 1. The voltage reduction amount represents the degree of short-circuiting caused by metallic Li. Thus, it can be said that short-circuiting was able to be suppressed more in each of Examples 1 to 5 than Comparative Example 1.

Examples 1 and 2 were for examining difference in effect according to the positions of the Li storage solids in the layering direction. As a result of the comparison of the results, the voltage reduction amount was extremely small in Example 2. The reason of this is considered to be because disposing the Li-occluding solid on peripheral end faces on the anode mixture layer side as in Example 2 could suppress metallic Li creeping up on the peripheral end faces at an early stage.

Examples 1, and 3 to 5 were for examining difference in placement position of the Li-occluding solid on peripheral end faces in the width direction (circumferential direction), and placement position of the current collector tabs. As a result of the comparison of the results, the voltage reduction amount was extremely small in each of Examples 1 and 4, where the Li-occluding solid was disposed across the peripheral end faces on the solid electrolyte layer in the circumferential direction. Example 3, where the Li-occluding solid was disposed on the peripheral end face, where the anode current collector tab and the cathode current collector tab were disposed as sticking out, showed the almost same result as Examples 1 and 4. In contrast, the voltage reduction amount was larger in Example 5, where the anode current collector tab and the cathode current collector tab were disposed on respective peripheral end faces opposite to each other as sticking out, and the Li-occluding solid was disposed on the peripheral end face, where the cathode current collector tab was disposed as sticking out, than Examples 1, 3 and 4. From these results, it was found that the Li-occluding solid was disposed on a peripheral end face where a current collector tab was disposed because currents are concentrated on a current collector tab and therearound, which promotes deposition of metallic Li. It is believed that the voltage reduction amount was larger in Example 5 than in Examples 1, 3 and 4 because the Li-occluding solid was not disposed on the peripheral end face, where the anode current collector tab was disposed.

The present disclosure is not limited to the above-described embodiments, and may be suitably modified within the scope not contrary to the gist and ideas of this disclosure which can be read in the claims and whole of the description. All-solid-state batteries with such modifications are also encompassed within the technical scope of this disclosure.

### REFERENCE SIGNS LIST

10, 20 all-solid-state lithium battery
11, 21 anode current collector
12, 22 anode mixture layer
13, 23 solid electrolyte layer
14, 24 cathode mixture layer
15, 25 cathode current collector
16 Li-occluding solid

What is claimed is:

1. An all-solid-state lithium battery, wherein
an anode mixture layer, a solid electrolyte layer, and a cathode mixture layer are layered in an order mentioned,
a Li-occluding solid is disposed on at least part of peripheral end faces on the solid electrolyte layer, and
the Li-occluding solid is responsive to Li.

2. The all-solid-state lithium battery according to claim 1, wherein
the peripheral end faces on the anode mixture layer, the solid electrolyte layer, and the cathode mixture layer are flat.

3. The all-solid-state lithium battery according to claim 1, wherein
the Li-occluding solid is disposed on the part of the peripheral end faces on the solid electrolyte layer on an anode mixture layer side.

4. The all-solid-state lithium battery according to claim 1, comprising:
an anode current collector disposed on a surface of the anode mixture layer, the surface being on an opposite side of the solid electrolyte layer; and
a cathode current collector disposed on a surface of the cathode mixture layer, the surface being on an opposite side of the solid electrolyte layer, wherein
the anode current collector includes an anode current collector tab,
the cathode current collector includes a cathode current collector tab,
the anode current collector tab and the cathode current collector tab are disposed on one same peripheral end face among the peripheral end faces as sticking out, and
the Li-occluding solid is disposed on a peripheral end face among the peripheral end faces on the solid electrolyte layer, the peripheral end face being the one same peripheral end face, where the anode current collector tab and the cathode current collector tab are disposed.

5. The all-solid-state lithium battery according to claim 1, wherein
the Li-occluding solid is disposed across the part of the peripheral end faces on the solid electrolyte layer in a circumferential direction.
